(19) United States
(12) Patent Application Publication
(10) Pub. No.: US 2011/0209366 A1
(43) Pub. Date: Sep. 1, 2011

(54) INTERACTIVE CARD

(76) Inventors: Liang-Hsiao Chao, Taipei Hsien (TW); Sheng-Fu Chao, Taipei Hsien (TW); Shu-Wun He, Taipei Hsien (TW)

(21) Appl. No.: 13/105,916

(22) Filed: May 12, 2011

Related U.S. Application Data
(63) Continuation-in-part of application No. 12/025,739, filed on Feb. 4, 2008, now abandoned.

(51) Int. Cl. G09F 11/04

(52) U.S. Cl. 40/446

(57) ABSTRACT

An interactive card comprises a base sheet being a thin plate, one side of the base sheet showing messages; and another side thereof having a shaft; a multi-layer rotary disk; each layer of the multi-layer rotary disk having an axial hole; the multi-layer rotary disk being rotatable with respect to the shaft; the multi-layer rotary disk including at least one window layer and at least one data layer; each window layer having a window; and the data layer being printed with indications at positions corresponding to the window; or the window and indications being arranged at the same layer; the indications on the layer can be viewed through the window. The window layers and the data layers are alternatively arranged around the shaft by the shaft to insert into the axial holes.

The present invention is a continuation in part of U.S. patent application Ser. No. 12/025,739 which is assigned to and invented by the inventor and applicant of the present invention. Thus, the content of U.S. patent application Ser. No. 12/025,739 is incorporated into the present invention as a part of the present invention.

### FIELD OF THE INVENTION

The present invention relates to interactive cards which combine a conventional card with other indication functions so as to enhance the impression of the message of the card and provides a further function by the indications.

### BACKGROUND OF THE INVENTION

Conventional cards, such as name cards, greeting cards, etc. cause the people owned the cards can know the message on the card. However currently, people receive a large amount of cards in daily life and thus it is often that the cards are deserted or stored and then lost so that the function of the cards is not effective.

In one prior art structure, the name card is formed with a line slot at one side of the card. An openable sheet is installed at one side of the slot. The sheet is printed with decorating patterns. The sheet is as a book clamper so as to provide the function of a name card, a decoration and a book clamper.

In another prior art, a card is printed with patterns or textures, and the front side and backside of the card are installed with double face tapes which is separable from the card. Thus the card can be adhered upon a glass or a surface of an object. Furthermore, a paper can be adhered upon the card so as to provide the functions of name cards, advertise sheet, memo sheets, etc.

Furthermore, above mentioned prior arts confine the use to some specific usages and can not be widely used in daily life so as to promote the function of the card greatly.

### SUMMARY OF THE INVENTION

The object of the present invention is to provide an interactive card which combines a conventional card with other indication function so as to enhance the impression of the message of the card and provides a further function by the indications.

To achieve above object, the present invention provides an interactive card, comprising: a base sheet being a thin plate, one side of the base sheet showing messages; and another side thereof having a shaft; a multi-layer rotary disk; each layer of the multi-layer rotary disk having an axial hole; a diameter of the axial hole being approximately greater or equal to that of the shaft so that the axial hole can receive the shaft and thus the multi-layer rotary disk is rotatable with respect to the shaft; the multi-layer rotary disk including at least one window layer and at least one data layer; each window layer having a window; and the data layer being printed with indications at positions corresponding to the window; and the indications on the layer can be viewed through the window; and

wherein the window layers and the data layers are alternatively arranged around the shaft by the shaft to insert into the axial holes.

Moreover, the present invention further provides an interactive card, comprising: a base sheet being a thin plate, one side of the base sheet showing messages; and another side thereof having a shaft; a multi-layer rotary disk; each layer of the multi-layer rotary disk having an axial hole; a diameter of the axial hole being approximately greater or equal to that of the shaft so that the axial hole can receive the shaft and thus the multi-layer rotary disk is rotatable with respect to the shaft; each layer of the multi-layer rotary disk having a window and indications at positions corresponding to the window of a layer at an upper side; and the indications on the layer can be viewed through the window.

The various objects and advantages of the present invention will be more readily understood from the following detailed description when read in conjunction with the appended drawing.

### BRIEF DESCRIPTION OF THE DRAWINGS

FIG. 1A is a schematic view of the base sheet of the present invention.

FIG. 1B is a schematic view about the cap of the present invention.

FIG. 2A is a schematic view about the first layer of the multi-layer rotary disk according to the present invention.

FIG. 2B is a schematic view about the second layer of the multi-layer rotary disk of the present invention.

FIG. 2C is a schematic view about the third layer of the multi-layer rotary disk of the present invention.

FIG. 2D shows the bottom layer of the multi-layer rotary disk of the present invention.

FIG. 3A shows the rear view of the present invention.

FIG. 3B shows the front view of the present invention.

FIG. 4A is a schematic view about the base sheet of the present invention.

FIG. 4B is a schematic view of the cap of the present invention.

FIG. 5A is a schematic view about the first layer of the present invention in another embodiment of the present invention.

FIG. 5B is a schematic view about the second layer of the present invention in another embodiment of the present invention.

FIG. 5C is a schematic view about the third layer of the present invention in another embodiment of the present invention.

FIG. 5D is a schematic view about the fourth layer of the present invention in another embodiment of the present invention.

FIG. 6 is a rear view of the present invention.

FIG. 7 shows the application of the present invention.

FIG. 8A shows an application of the present invention.

FIG. 8B shows another application of the present invention.

### DETAILED DESCRIPTION OF THE INVENTION

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

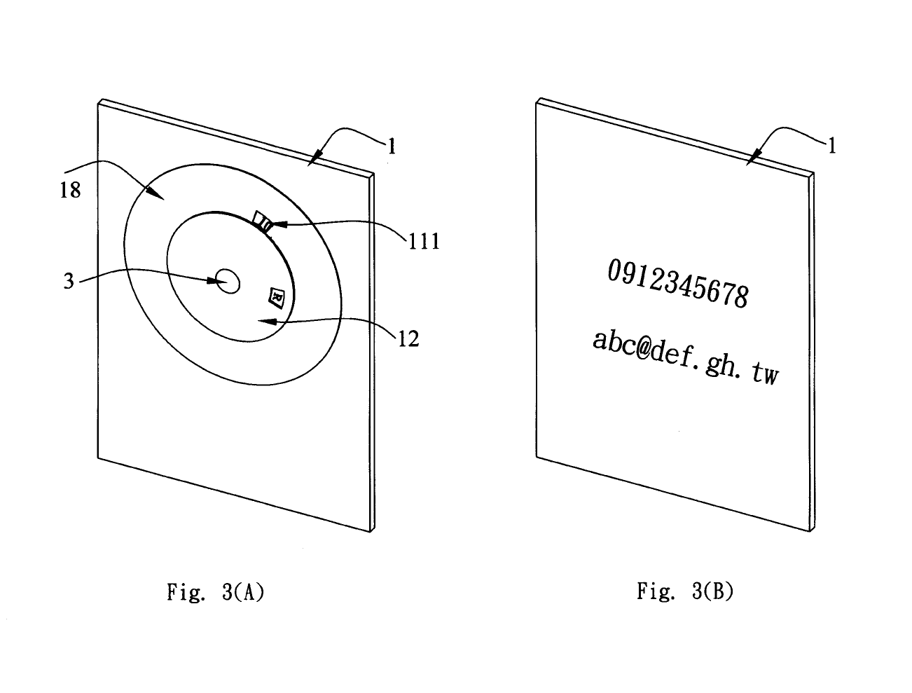

Referring to FIG. 3, the first embodiment of the interactive card according to the present invention is illustrated. The present invention has the following elements.

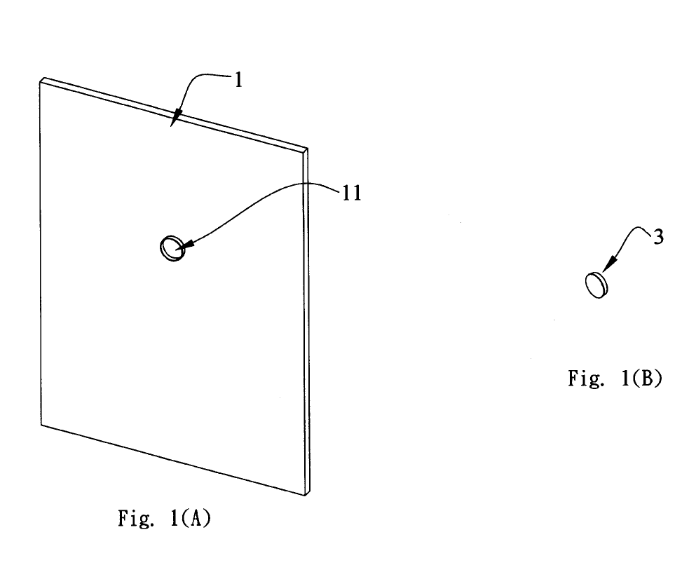

A base sheet 1 is a thin plate. One side of the base sheet 1 is printed with messages. Another side of the base sheet 1 has a shaft 11 for engaging other elements (see FIG. 1A). The shaft 11 may be formed by punching the base sheet 1 or is installed to the base sheet 1 by adhering or gluing or suturing.

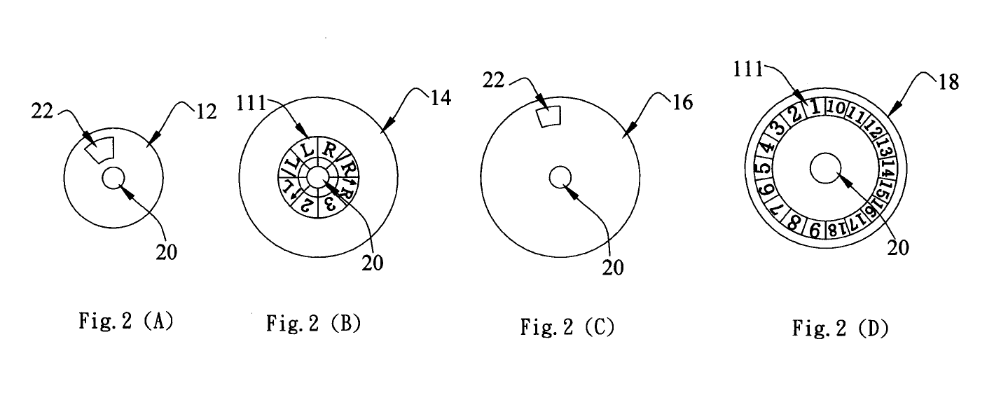

A multi-layer rotary disk has for example four layers including a first layer 12, a second layer 14, a third layer 16 and a fourth layer 18. In this embodiment, the multi-layer rotary disk has an approximate round shape. Each layer has an axial hole 20. A diameter of the axial hole 20 is slightly larger than a diameter of the shaft 11 for receiving the shaft 11 corresponding to the layers 12, 14, 16 and 18 so that the layers of the mobile device are rotatable with respect to the shaft 11 (see FIGS. 2A to 2D).

In this embodiment, the first layer 12 and third layer 16 of the multi-layer rotary disk are window layers. Each window layer has a window 22. The second layer 14 and fourth layer 18 are data layers. The surface of the data layer is printed with data to be displayed. By the window 22 of the window layer, the data on the data layer below the window 22 can be seen. In this embodiment, the indications 111 on the second layer 14 and fourth layer 18 are numbers (such as 0, 1, 2, 3, 4, 5, . . . ) and English alphas (from A to Z)j [X]. The indications 111 are arranged around the axial hole 20.

In an optimum arrangement, an area of the layer at an upper side is not greater than that of a layer at a lower side so that the operation can be performed easily.

A cap 3 can be engaged to the shaft 11 or is adhered to or glue to or sutured to the shaft 11. The area of the cap 3 is greater than that of the shaft 11 for preventing the layers to release from the shaft 11 (referring to FIG. 1B).

Referring to FIG. 3A, in assembly, each layers 12, 14, 16 and 18 are engaged to the shaft 11 extended from the base sheet 1 by the shaft 11 inserting into the axial holes 20 of the layers of the multi-layer rotary disk. Finally, the cap 3 is installed at a top end of the shaft 11. The area of the cap 3 is greater than that of the shaft 11 for preventing the layers to release from the shaft 11.

The present invention has wide applications, such as general used cards, for example name cards, or bookmarkers, labels, tickers, memos, furthermore, the book of itself etc. The indications 111 on the layers of the multi-layer rotary disk may be numbers, symbols, alphas, words, etc. for indicting chapters, pages, paragraphs, sections, of a book, or dates for something to be recorded.

The present invention can be objects, such as conventional bookmarkers, name cards, memos of marriage, IC cards, book of itself, etc. so as to increase the utilities of these objects and thus the cards will keep the attention of the owners (referring to FIG. 3B).

Referring to FIG. 3A, the application of the present invention will be described with reference to the drawing. In this example, the indications 111 are chapters, pages, lines, etc. for indicating a section that the reader reads. In the operation, for example, the first layer 12 is rotated to R and the third layer 16 is rotated to 10. Thus the user can know where he (or she) reads, in this example, it indicates that the place to be read next time is at line 10 from the right side of the page. However the present invention can also be used to indicate a date. In the example, the first layer 12 is rotated to an indication of 01, and the third layer 16 is rotated to 01, which represents a date of Jan. 1 so as to alert the user that at that day, a matter is necessary to be treated. However the present invention has many applications not confining to above said example.

Preferably, the present invention is applied to name cards. When the name card is combined with the present invention, by the application of the present invention, the name card has more usages and thus the user may have deep impressions to name card. The name card will be retained with long time and the owners can view the name cards with higher frequency. Thus it generates an advertise effect, this is especially advantageous for the businessmen.

In the following, the second embodiment of the present invention will be described with reference to the appended drawings. In this embodiment, those identical to the above embodiment will be identical to the same numerals.

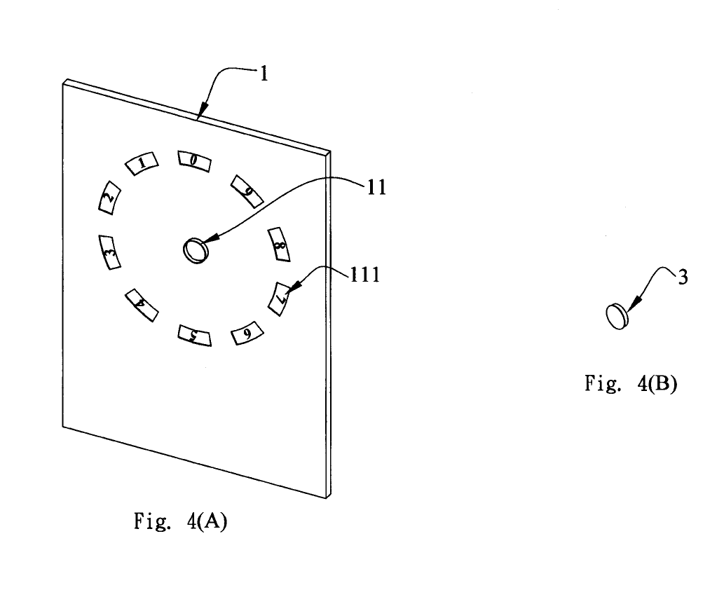

A base sheet 1 may have indication 111 on a surface thereof. One side of the base sheet 1 is printed with messages. Another side of the base sheet 1 has a shaft 11 for engaging other elements (see FIG. 4A). The shaft 11 may be formed by punching the base sheet 1 or is installed to the base sheet 1.

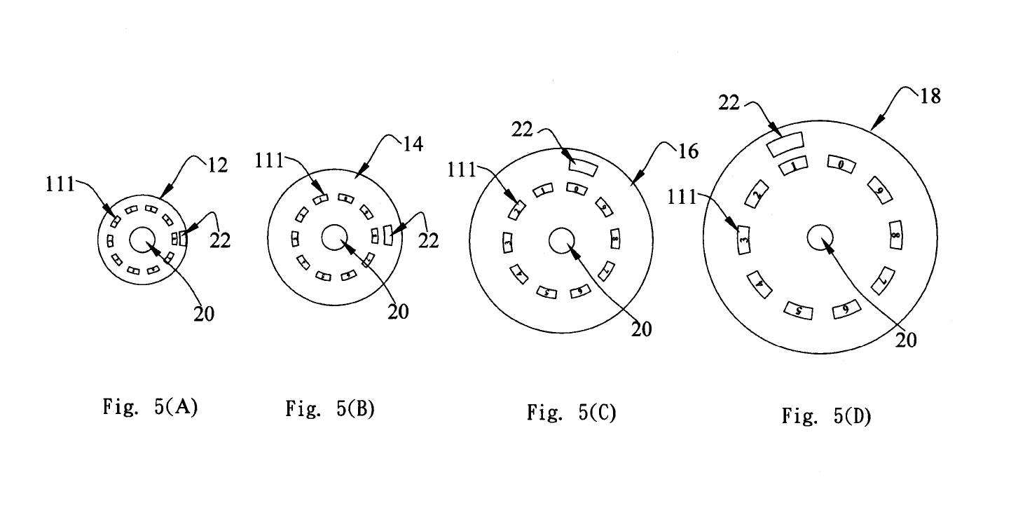

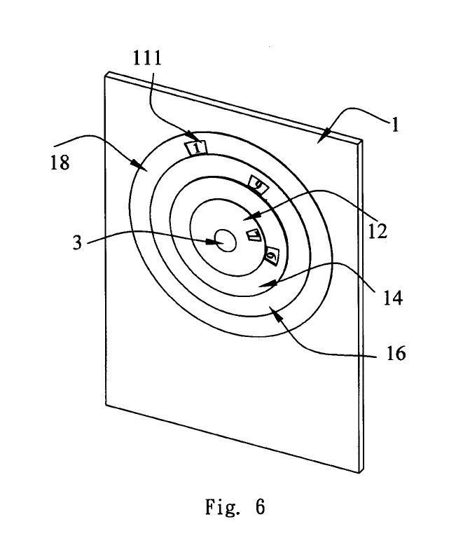

A multi-layer rotary disk has for example four layers including a first layer 12, a second layer 14, a third layer 16 and a fourth layer 18. In this embodiment, the multi-layer rotary disk has an approximate round shape. Each layer has an axial hole 20. A diameter of the axial hole 20 is slightly larger than a diameter of the shaft 11 for receiving the shaft 11 corresponding to the layers 12, 14, 16 and 18 so that the layers are rotatable with respect to the shaft 11. Each layer of the multi-layer rotary disk has a window 22 and indication 111 which are at the same plane. In this embodiment, the indications 111 on each layer are numbers (such as 0, 1, 2, 3, 4, 5, . . . ) and English alphas (from A to Z)j [x]. The indications 111 are arranged around the axial hole 20 (referring to FIGS. 5A to 5D).

In an optimum arrangement, an area of the layer at an upper side is not greater than that of a layer at a lower side so that the operation can be performed easily.

In an optimum arrangement, an area of the layer at an upper side is not greater than that of a layer at a lower side so that the operation can be performed easily.

A cap 3 can be engaged to the shaft 11 or is adhered to or glue to or sutured to the shaft 11. The area of the cap 3 is greater than that of the shaft 11 for preventing the layers to release from the shaft 11 (referring to FIG. 4B).

An operation example of the present invention will be described herein. In this example a window 22 of a fourth layer is rotated to 1; the third layer is rotated to 9, the second layer is rotated to 6 and the first layer is rotated to 7. It represents that an indication of chapter 1, section 9, paragraph 6 and line 7.

In above two embodiments, the indication 111 may be numbers, constellations, arrows, alphas, textures, patterns, etc.

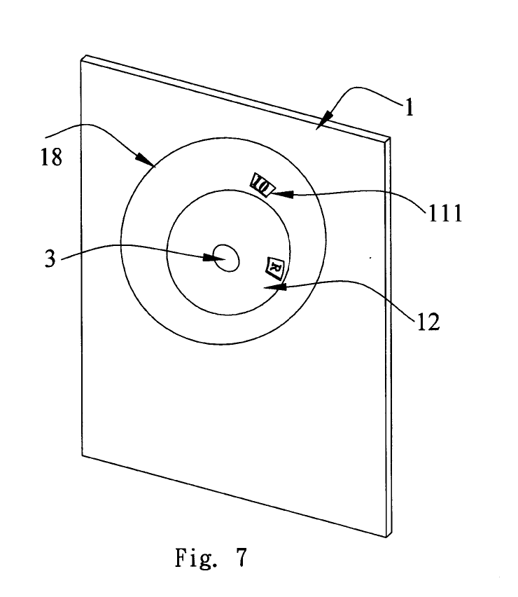

Referring to FIG. 7, the shape of each layer in the multi-layer rotary disk is not confined to round shapes, it may be elliptical shapes or other regular shapes or irregular shapes,

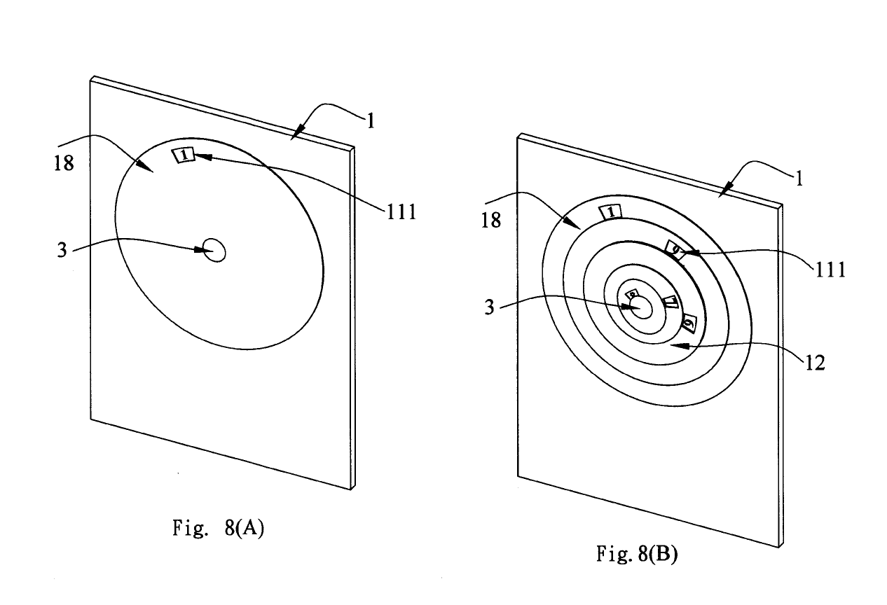

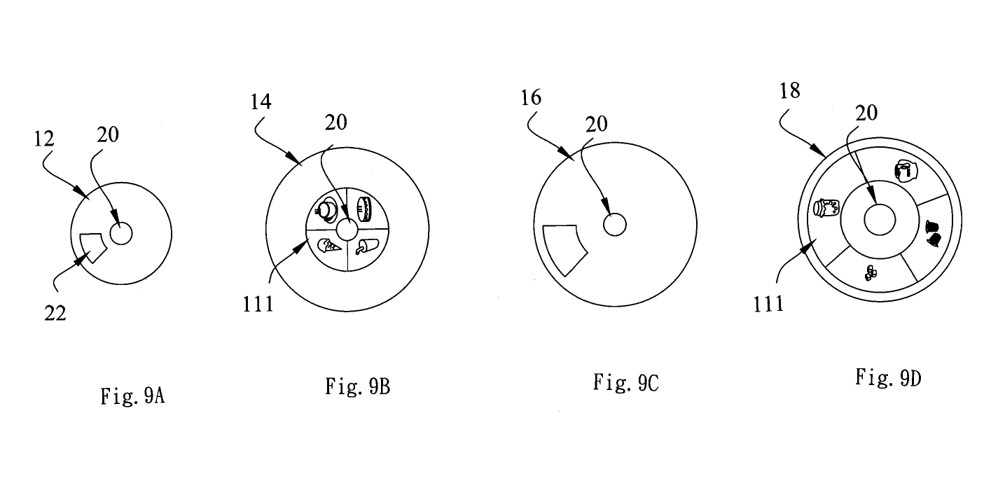

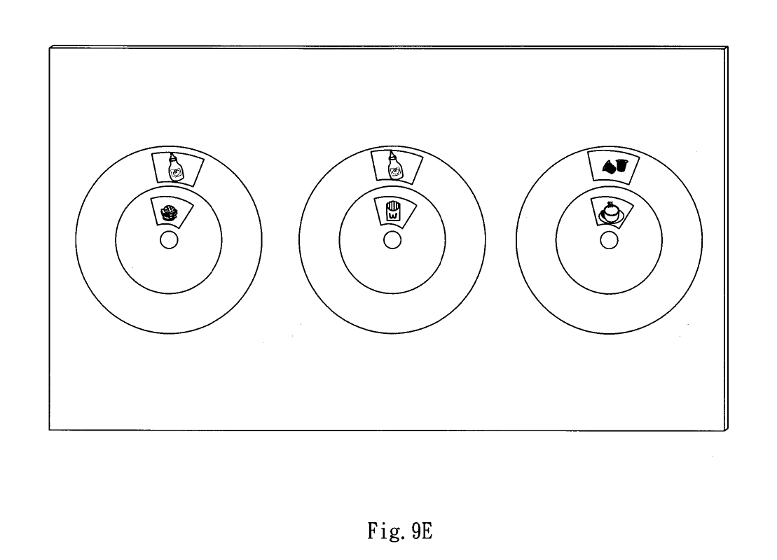

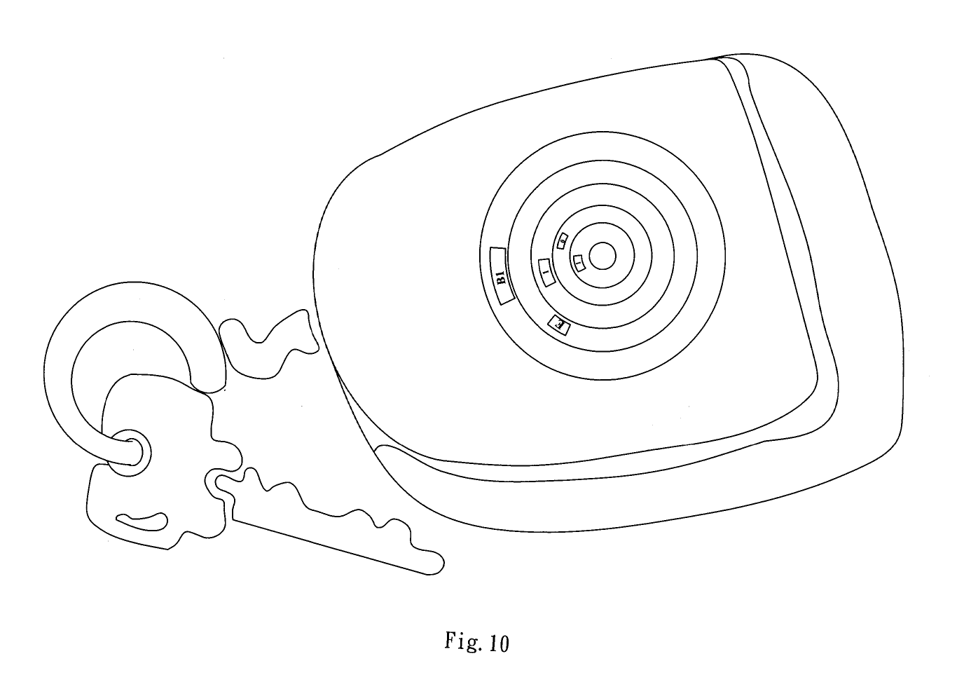

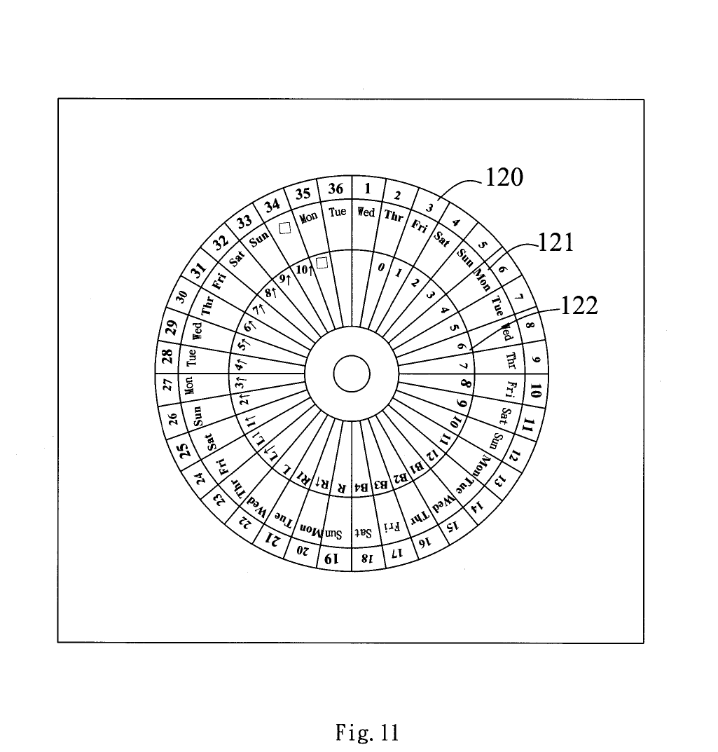

Referring to FIGS. 8A to 8B, it should be noted that the number of the layers of the multi-layer rotary disk is not limited to four.

Furthermore, it should be noted that in the present invention, the window may be a penetrating hole or a transparent area in the layer of the multi-layer rotary disk or indicators.

Referring to FIGS. 9A and 9B, the application of the present invention is illustrated. In this embodiment, the card of the present invention is used as a menu for selection of the combination of foods. For example, as illustrated in FIG. 9A, it is illustrated that the first layer of the multi-layer rotary disk shows a plurality of desserts, and the second layer of the disk shows a plurality of juicy. Thus different desserts and juicy can be combined by dialing the layers of disk. Thus the customer can select a combination of the foods by using the rotary disk and then provides the disk to the waiter.

Referring to FIG. 10, it is illustrated that the present invention is used with a car key. Thus when the driver has parked a car on a parking lot, he (or she) can record the number of the parking lot for the car on the multi-layer rotary disk so that the user need not remember the park lot number.

Referring to FIG. 11, another embodiment of the present invention is illustrated. It is illustrated that the present invention is used as a calendar. In this embodiment, there are three layers on the rotary disk. A first layer shows the numbers from 1 to 31 representing different days of a month, the second layer repeatedly shows the numbers from 1 to 7 representing the different days of a week, and the third layer shows the number from 1 to 12 representing the number of months in one year. In use, the user just needs to align the three layers to a specific day. Then from the disk, he or she can know the information about the days in that month.

Moreover, in the present invention, the multi-layer disk may be used to record the information of menses, such as safety period, critical period, and ovulation period.

In the present invention, materials of the substrates and multi-layer rotary disks are selected from paper, plastics, metals, or non-metal, or the compound thereof.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. An interactive card, comprising:
a base sheet being a thin plate, one side of the base sheet showing messages; and another side thereof having a shaft;
at lest one multi-layer rotary disk on one side of the base sheet; each layer of the multi-layer rotary disk having an axial hole; a diameter of the axial hole being approximately greater or equal to that of the shaft so that the axial hole can receive the shaft and thus the multi-layer rotary disk is rotatable with respect to the shaft; and
wherein an area of the base sheet is greater than that of any layer of the multi-layer rotary disk.

2. The interactive card as claimed in claim 1, wherein the base sheet has a rectangular shape.

3. The interactive card as claimed in claim 2, wherein the multi-layer rotary disk includes at least one window layer and at least one data layer; each window layer has a window; and the data layer is printed with indications at positions corresponding to the window; and the indications on the layer can be viewed through the window; and
wherein the window layers and the data layers are alternatively arranged around the shaft by the shaft to insert into the axial holes

4. The interactive card as claimed in claim 2, wherein each layer of the multi-layer rotary disk has a window and indications at positions corresponding to the window of a layer at an upper side; and the indications on the layer can be viewed through the window.

5. The interactive card as claimed in claim 3, wherein the window is one of a penetrating hole, a transparent area and indicators.

6. The interactive card as claimed in claim 4, wherein the window is one of a penetrating hole, a transparent area and indicators.

7. The interactive card as claimed in claim 3, wherein the base sheet has a rectangular shape and each layer of the multi-layer rotary disk has an approximate round shape; and an area of the layer at an upper side is not greater than that of a layer at a lower side so that the operation can be performed easily.

8. The interactive card as claimed in claim 1, further comprising a cap installed upon the shaft; and an area of the cap is slightly greater than that of the shaft.

9. The interactive card as claimed in claim 1, wherein there are a plurality of multi-layer rotary disks arranged on the base sheet.

10. The interactive card as claimed in claim 1, wherein the base sheet is one of bookmarkers, name cards, memos of marriage, IC cards, a key card, and books.

11. The interactive card as claimed in claim 1, wherein the indication serves to indicate a date or a time so as to indicate a date or a time of an affair to be kept attention.

12. The interactive card as claimed in claim 1, wherein the indications are selected from at least one of numbers, constellations, arrows, alphas, symbols, and patterns.

13. The interactive card as claimed in claim 1, wherein the multi-layer rotary disk has three layers which indicated the day, week and month for being used as a calendar.

14. The interactive card as claimed in claim 1, wherein different layers of the multi-layer rotary disk indicate different foods so as to form with different combination of the foods.

15. The interactive card as claimed in claim 1, wherein different layers in the multi-layer rotary disk show the information of menses about safety period, critical period, and ovulation period.
